(19) United States
(12) Patent Application Publication
(10) Pub. No.: US 2018/0164252 A1
(43) Pub. Date: Jun. 14, 2018

(54) FIELD DEVICE FOR DETERMINING FLUID PROPERTIES COMPRISING A FLUID SENSOR, A TEMPERATURE SENSOR AND A PROCESSING FACILITY MOUNTED ON A FLUID VESSEL

(71) Applicant: Rosemount Measurement Limited, Berkshire (GB)

(72) Inventors: Jeffery Allan Sears, Berkshire (GB); Gregory Michael Leach, Berkshire (GB); Marianne Elizabeth Williams, Berkshire (GB); Rehan Azfar Ashraf, Berkshire (GB)

(73) Assignee: Rosemount Measurement Limited, Berkshire (GB)

(21) Appl. No.: 15/574,562

(22) PCT Filed: May 18, 2016
(86) PCT No.: PCT/GB2016/051431

§ 371 Date: Nov. 16, 2017

(30) Foreign Application Priority Data
May 18, 2015 (GB) 1508474.2

(51) Int. Cl. G01N 29/02; G01N 9/00; G01N 29/036; G01N 29/12

(52) U.S. Cl. CPC G01N 29/022; G01N 29/12; G01N 29/036; G01N 9/002

(57) ABSTRACT

The invention provides a field device configured to be fitted through a single mounting aperture in a vessel. The device preferably includes a vibrating fork and a temperature sensor, the signals from which are processed within the device to provide an output indicative of whether a property of a medium in contact with the device is above or below a threshold. This output may be communicated wirelessly to a remote location. Other features are described.

### FIELD OF THE INVENTION

This invention relates to field devices and more particularly, though not necessarily solely, to a vibrating fork field device.

### BACKGROUND OF THE INVENTION

A vibrating fork field device, mounted in the wall of a vessel, provides a reliable and convenient means for detecting the presence of an interface in the vessel. However detecting the presence and constituents of an interface is difficult and may be costly if multiple interfaces and/or an emulsion layer are present. The interface may not be obvious when separating, for example, methanol in water, diesel and green diesel, and black liquor and soap. Further, if the uppermost interface has a high dielectric constant (dk) the use of a radar-based detection instrument is not feasible because the radar signal cannot penetrate to lower interfaces; and a radar signal has difficulty is identifying an interface if the dielectric constant between layers is less than 10 dk. Radar also has difficulty penetrating emulsion layers more than a few inches thick.

The above factors must be considered in light of a general desire or need to measure multiple variables in a single process medium and to communicate measurement data to a remote location. Typically, however, multiple instruments must be employed which not only adds cost to an installation but also requires multiple intrusions to be made through the wail of the process vessel. This goes against safety best-practice.

It is an object of this invention to provide a field device that will go at least some way to addressing the aforementioned problems and requirements; or which will at least provide a novel and useful choice.

### SUMMARY OF THE INVENTION

Accordingly in a first aspect the invention provides a field device having a mounting engageable through a wall of a vessel; a first sensor positioned on said mounting and operable to generate a change in frequency signal in response to a change in property of a medium in contact with said sensor within said vessel; a second sensor positioned on said mounting and operable to generate a change in temperature signal in response to a change in temperature of said medium in said vessel and in contact with said second sensor; said field device further including a processing facility positioned on said mounting and operable to receive signals derived from said first and second sensors, to use a signal from said second sensor to apply temperature compensation to a signal from said first sensor, and to generate an output signal indicative of whether a property of said medium is above or below a threshold; and a communications facility operable to communicate said output signal to a remote location.

Preferably said mounting includes a flange to engage with said vessel, said first and second sensors being positioned to one side of said flange and said processing facility being positioned to an opposite side of said flange.

Preferably said processing facility is operable to generate an alarm signal if a frequency, temperature, or property derived therefrom falls outside one or more limits.

Preferably said field device further includes a local operator interface operable to enable setting of said threshold.

Preferably said communications facility is configured and operable to enable setting of said threshold

Preferably said field device is battery powered.

Preferably said property is density.

Alternatively said property is viscosity.

Alternatively said property is alcohol content.

Alternatively said property is sugar content.

Alternatively said property is contamination of said medium.

Preferably said communications facility is further operable to report frequency and temperature readings, and data indicative of said property.

In a second aspect the invention provides a method of establishing if a property of a fluid contained in a vessel is above or below a threshold, said method using a vibrating fork field device that vibrates at a frequency dependent on a property of said fluid in contact with said field device, said method including the steps of:

inserting said field device through a single penetration in a wall of said vessel;

causing said field device to vibrate at a first frequency;

noting a second frequency being a change in said first frequency in response to a change in a property of said fluid;

applying temperature compensation to said first frequency and said second frequency using a temperature sensor inserted into said vessel through said single penetration;

within said field device processing a temperature compensated first frequency and a temperature compensated second frequency derive a variable indicative of whether said property is above or below a threshold; and

wirelessly communicating said variable to a remote location.

Preferably said method further includes effecting a switching operation in response to said variable crossing said threshold.

Preferably said method is applied to establishing if a density of a medium, or a property of a medium that varies with density, is above or below a threshold.

Many variations in the way the invention may be performed will present themselves to those skilled in the art, upon reading the following description. The description should not be regarded as limiting but rather as an illustration, only, of one manner of performing the invention. Where appropriate any element or component should be taken as including any or all equivalents thereof whether or not specifically mentioned

### BRIEF DESCRIPTION OF THE DRAWINGS

The invention will now be described with reference to the accompanying drawings in which:

FIG. 1: shows a view of a field device according to the invention mounted in position on a process vessel;

FIG. 2: shows a schematic functional diagram of the device shown in FIG. 1;

FIG. 3: shows plots of changes in sensor frequency when wet and when dry, without temperature compensation;

FIG. 4: shows changes in sensor frequency with varying temperature, for different fluid properties (in this example density), without temperature compensation; and

FIG. 5: shows changes in sensor frequency with varying temperature, for different fluid properties (in this example density), after temperature compensation.

### DETAILED DESCRIPTION OF WORKING EMBODIMENTS

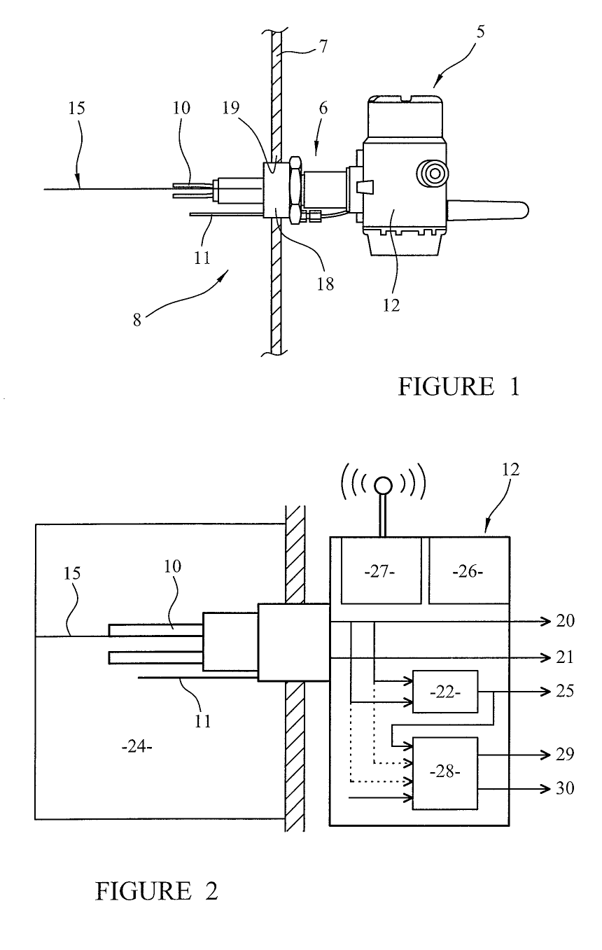

Referring firstly to FIG. 1, the invention provides a field device 5 having a mounting 6 engaged in a penetration or aperture in a wail 7 of a vessel 8. The device 5 includes a first sensor 10 positioned on the mounting 6 and operable to generate a change in frequency signal in response to a change in medium in contact with the sensor 10 within the vessel 8; and a second sensor 11, also positioned on the mounting 6, and operable to generate a change in temperature signal in response to a change in temperature of the medium in the vessel 8 and in contact with the second sensor 11, although it will be appreciated that the sensor 11 may be incorporated directly within the sensor 10. The field device 5 further includes a processing facility 12 positioned on the mounting 6 and operable to derive at least one property of the medium in contact with sensors 10 and 11 from signals derived from the sensors 10 and 11.

It will be appreciated by those skilled in the art that the sensor 10 can conveniently be provided in the foul' of a vibrating fork while the sensor 11 preferably comprises a temperature probe. Changes of frequency and temperature will typically be experienced when a fluid interface 15 rises or falls into contact with the sensor 10. These changes can be output directly to indicate that the interface 15 is at the position of the field device 5 or the frequency and temperature signals can be processed in the processing facility 15 to produce other information of interest, examples of which will be described in greater detail below.

In the particular form shown the mounting 6 includes a flange 18 to engage with an aperture 19 in the wall 7. It can be seen that the sensors 10 and 11 are positioned to one side of the flange while the processing facility 12 is positioned to an opposite side of flange. This ensures that the sensors are positioned on the inside of the vessel 8 whilst the processing facility is positioned to the outside of the vessel.

Field devices in the form of vibrating fork level switches are commonly used for indicating the presence or absence of liquids. Typically the change in is resonant frequency of the vibrating fork sensor between wet and dry is in excess of 20% of the frequency when dry. Thus it is simple to detect the difference between wet and dry using a relatively coarse frequency measurement. However the invention is principally concerned with monitoring fluid properties when the sensor 10 is constantly immersed in a particular fluid. More particularly, the invention is not so much concerned with establishing an accurate measurement of a particular property but whether or not a property is above or below a threshold or switching point.

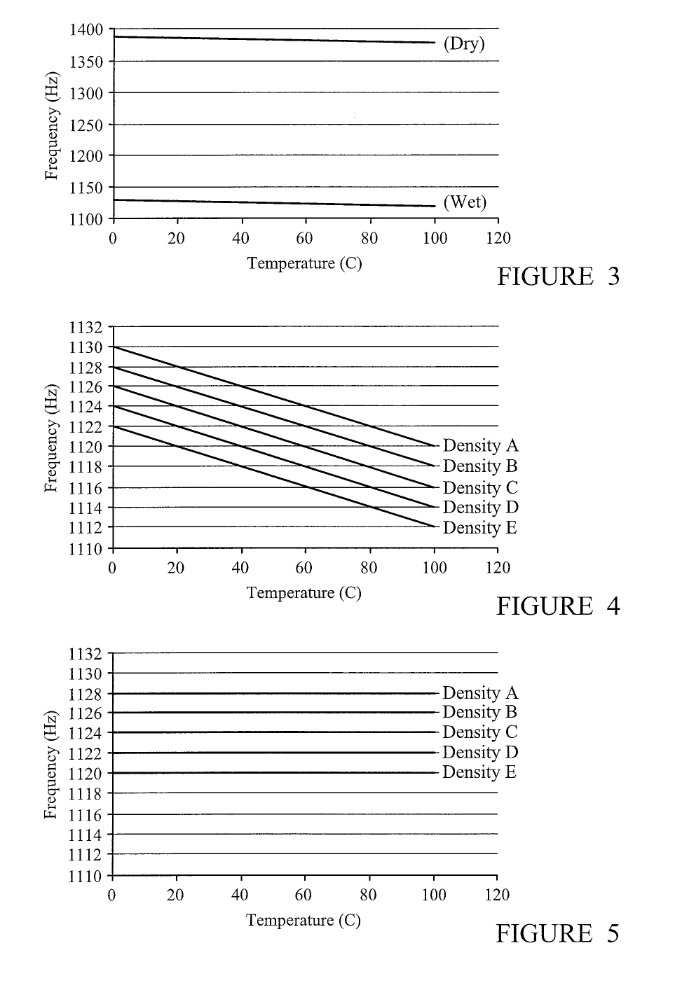

As shown in FIG. 3, the resonant frequency of a vibrating fork sensor also varies with temperature but the temperature coefficient is generally low enough that the change in frequency does not significantly effect the level at which the sensor reports a change between wet (the lower line) and dry (the upper line). However, in applications in which the sensor is being used to indicate a change in properties of a medium, for example liquid density, the sensor is always wet and the change of frequency to be measured in order to detect the target change in property is significantly smaller. Referring to FIG. 4, plots are shown of the changes in frequency with temperature of media of five different densities. As illustrated, the measured frequency values typically decrease with increasing temperature upon the sensor material and medium density. For this reason it is not possible to specify a particular frequency value to represent a threshold between two or more values of the density of the medium.

Referring now to FIG. 5, adding temperature compensation to the frequency value results in a more stable frequency measurement and thus one or more thresholds or switching points between two or more values of density of the medium can then be specified.

A number of fluid properties such as viscosity, alcohol content, sugar content and contamination vary with density and thus the frequency of vibration of a vibrating fork field device will also vary with variations in these properties. Knowledge of the medium in contact with the sensor therefore means that frequency points or set points can be identified which are indicative of properties of the medium. In particular whether that property is above or below a value of significance to a process operator.

Reverting to FIG. 2, signals from the sensors 10 and 11 can be output at 20 and 21 respectively to provide diagnostic indications of frequency and temperature. In addition, signals from the sensors 10 and 11 are directed to a calculation block 22 in which frequency is converted into a derived variable, being a property of the medium of interest to the user or operator. The derived variable could, for example, be density, viscosity, alcohol content, sugar content or degree of contamination. The field device may be configured at place and time of manufacture to switch at a particular target variable or may be configured in the field using a local operator interface facility 26, the facility being also preferably configured to indicate outputs from the sensors 10 and 11 and of the derived variable from the calculation block 22. This embodiment further shows the use of a communication facility 27 functionally interlinked to the processing block 22. The facility 27 enables configuration of the device from a remote site and also provides a means of communicating outputs from the sensors 10 and 11, and the derived variable, to a remote site.

In keeping with the objective of providing a multi-variable low cost device, the communication facility 27 is a wireless communication facility.

Also shown diagrammatically in FIG. 2 is an alarm facility 28 functionally linked to the sensors 10 and 11 and to the calculation block 22. The alarm facility 28 outputs alarm signals at, for example, 29 and 30 in the event the frequency, temperature or derived variable fall outside established parameters. The alarm signals may also be communicated to a remote location using the communications facility 27.

The field device 5 as described may be powered from a wired connection or from one or more batteries.

It will thus be appreciated that the present invention provides a field device that can perform a variety of measurements in relation to a medium contained in a vessel, through a single intrusion of that vessel. Data from sensors contained in the device is processed internally of the device to provide output values or states indicative of one or more properties of the medium. Given the inclusion of measurement, data processing and output control in a single device, costs of procurement, installation, commissioning and maintenance are lowered; and safety is enhanced.

1. A field device having a mounting engageable through a wall of a vessel; a first sensor positioned on said mounting and operable to generate a change in frequency signal in response to a change in property of a medium in contact with said sensor within said vessel; a second sensor positioned on said mounting and operable to generate a change in temperature signal in response to a change in temperature of said medium in said vessel and in contact with said second sensor; said field device further including a processing facility positioned on said mounting and operable to receive signals from said first and second sensors, to use a signal from said second sensor to apply temperature compensation to a signal from said first sensor, and to generate an output signal indicative of whether a property of said medium is above or below a threshold; and a communications facility operable to communicate said output signal to a remote location.

2. A field device as claimed in claim 1 wherein said mounting includes a flange to engage with said vessel, said first and second sensors being positioned to one side of said flange and said processing facility being positioned to an opposite side of said flange.

3. A field device as claimed in claim 1 wherein said processing facility is operable to generate an alarm signal if a frequency, temperature, or a property derived therefrom, falls outside one or more limits.

4. A field device as claimed in claim 1 further including a local operator interface operable to enable setting of said threshold.

5. A field device as claimed in any claim 1 wherein said communications facility is configured and operable to enable setting of said threshold.

6. A field device as claimed in claim 1 when battery powered.

7. A field device as claimed in claim 1 wherein said property is density.

8. A field device as claimed in claim 1 wherein said property is viscosity.

9. A field device as claimed in claim 1 wherein said property is alcohol content.

10. A field device as claimed in claim 1 wherein said property is sugar content.

11. A field device as claimed in claim 1 wherein said property is contamination of said medium.

12. A field device as claimed in claim 1 wherein said communications facility is further operable to report frequency and temperature readings, and data indicative of said property.

13. A method of establishing if a property of a fluid contained in a vessel is above or below a threshold, said method using a vibrating fork field device that vibrates at a frequency dependent on a property of said fluid in contact with said field device, said method including the steps of:
inserting said field device through a single penetration in a wall of said vessel;
causing said field device to vibrate at a first frequency;
noting a second frequency being a change in said first frequency in response to a change in a property of said fluid;
applying temperature compensation to said first frequency and said second frequency using a temperature sensor inserted into said vessel through said single penetration;
within said field device processing a temperature compensated first frequency and a temperature compensated second frequency to derive a variable indicative of whether said property is above or below a threshold; and
communicating said variable to a remote location.

14. A method as claimed in claim 13 further including effecting a switching operation in response to said variable crossing said threshold.

15. A method as claimed in claim 13 when applied to establishing if a density of a medium, or a property of a medium that varies with density, is above or below a threshold.
